(19) United States
(12) Patent Application Publication
(10) Pub. No.: US 2015/0226931 A1
(43) Pub. Date: Aug. 13, 2015

(54) OPTICAL LENS ASSEMBLY HAVING AN OPTICAL REFRACTIVE INDEX MATCHING LAYER

(71) Applicant: LARGAN PRECISION CO., LTD., Taichung (TW)

(72) Inventor: YEO-CHIH HUANG, Taichung (TW)

(73) Assignee: LARGAN PRECISION CO., LTD., Taichung (TW)

(21) Appl. No.: 14/248,031

(22) Filed: Apr. 8, 2014

(30) Foreign Application Priority Data
Feb. 11, 2014 (TW) 103202367

(51) Int. Cl. G02B 7/02

(52) U.S. Cl. CPC G02B 7/021; G02B 7/026

(57) ABSTRACT

The present invention provides an optical lens assembly, comprising: a lens barrel made of plastic material and having a lens insertion opening and a lens barrel central axis, the lens barrel accommodating a first lens element with refractive power, a second lens element with refractive power made of plastic material, a third lens element with refractive power, and an optical refractive index matching layer disposed between the lens barrel and the second lens element, and respectively connecting the lens barrel and the second lens element; wherein the first lens element is disposed farther from the lens insertion opening than the second lens element, and the second lens element is disposed farther from the lens insertion opening than the third lens element; and wherein there is an air space between any two adjacent lens elements on the lens barrel central axis.

### BACKGROUND OF THE INVENTION

1. Field of the Invention

The present invention relates to an optical lens assembly, and more particularly, to an optical lens assembly having an optical refractive index matching layer.

2. Description of the Prior Art

The unexpected light in an optical lens assembly may cause flare, ghost or a decrease in the overall image contrast and adversely affect the image quality. In addition to the multiple reflections between the lenses, the unexpected light may be the result of reflections from other discontinuous interfaces in the lens assembly, such as the reflection from the interface between the outer edge of the lens and air, or the reflection from the inner edge of the lens barrel. To eliminate the multiple reflections, the lenses in a modern lens assembly are usually coated with multiple anti-reflection layers to increase the transmittance thereof and reduce the unexpected reflections therebetween. To eliminate the reflection from the inner edge of the lens barrel, the interior of the lens barrel is usually made of a dark-colored material, and the inner surface of the lens barrel may also be provided with a coating to increase the light absorption rate of the lens barrel.

The reflection from the interface between the outer edge of the lens and air is another problem to be solved in lens design. In an optical lens assembly, the lenses are fixed inside the lens barrel. As described above, although the anti-reflection processing is usually performed on the inner edge of the lens barrel, there is a gap between the outer edge of the lens and the inner edge of the lens barrel, and thus the outer edge of the lens is actually in direct contact mainly with air. Optical glasses or optical plastic materials are common materials used to fabricate lenses. Such materials are significantly different in refractive index from air. For a lens made of any of such materials, the interface between the outer edge thereof and air causes the occurrence of full reflection easily and results in the formation of unexpected light in the lens assembly. In the past, a dark light-absorbing material, such as the carbon black disclosed in U.S. Pat. No. 4,332,706 or the anti-reflection black material disclosed in the US Publication No. 2005/0226608, is often disposed between the outer edge of the lens and the lens barrel to increase the light absorption rate and thereby to reduce the reflection.

### SUMMARY OF THE INVENTION

In view of the aforementioned prior art, the present invention proposes an improved method that prevents the occurrence of full reflection from the aforementioned lens edge by adding an optically transmissive optical refractive index matching layer between the outer edge of the lens and the lens barrel.

The present invention provides an optical lens assembly, comprising: a lens barrel made of plastic material and having a lens insertion opening and a lens barrel central axis, the lens barrel accommodating a first lens element with refractive power, a second lens element with refractive power made of plastic material, a third lens element with refractive power, and an optical refractive index matching layer disposed in a gap between the lens barrel and the second lens element and respectively connecting the lens barrel and the second lens element; wherein the first lens element is disposed farther from the lens insertion opening than the second lens element, and the second lens element is disposed farther from the lens insertion opening than the third lens element; and wherein there is an air space between the first lens element and the second lens element on the lens barrel central axis, and there is another air space between the second lens element and the third lens element on the lens barrel central axis.

In the optical lens assembly of the present invention, it is preferable that the second lens element has a second lens element fitting surface abutting against an adjacent lens and forming an angle A together with the lens barrel central axis. The angle A satisfies the following relation: |A|<45 degrees.

In the optical lens assembly of the present invention, it is preferable that the second lens element fitting surface is arranged at the side of the second lens element farther away from the lens insertion opening.

In the optical lens assembly of the present invention, it is preferable that the first lens element has a first lens element fitting surface lap joining the second lens element fitting surface and arranged farther away from the lens barrel central axis than the second lens element fitting surface.

In the optical lens assembly of the present invention, it is preferable that the second lens element comprises a front side surface facing away from the lens insertion opening and a back side surface facing the lens insertion opening, and that each of the front side surface and the back side surface comprises a second lens element fitting surface.

In the optical lens assembly of the present invention, it is preferable that at least one of the first lens element and the second lens element has at least one aspheric surface.

In the optical lens assembly of the present invention, it is preferable that a visible light absorption rate of the lens barrel is Ab which satisfies the following relation: Ab>80%.

Preferably, the optical lens assembly of the present invention comprises a ring-shaped optical component disposed at one side of the second lens element.

In the optical lens assembly of the present invention, it is preferable that the ring-shaped optical component has an outer diameter Ds and the second lens element has an outer diameter D2, and they satisfy the following relation: Ds/D2<1.

In the optical lens assembly of the present invention, it is preferable that a refractive index of the optical refractive index matching layer is n_{c} and a refractive index of the second lens element is n₂, and they satisfy the following relation: 0.75<n_{c}/n₂<1.50.

In the optical lens assembly of the present invention, it is preferable that the refractive index of the optical refractive index matching layer is n_{c} and the refractive index of the second lens element is n₂, and they further satisfy the following relation: 0.8<n_{c}/n₂<1.2.

In the optical lens assembly of the present invention, it is preferable that the optical refractive index matching layer is made of a polymer material.

In the optical lens assembly of the present invention, it is preferable that a visible light transmittance of the optical refractive index matching layer is Tc which satisfies the following relation: Tc>80%.

The present invention provides another optical lens assembly, comprising: a lens barrel made of plastic material and having a lens insertion opening and a lens barrel central axis, the lens barrel accommodating a first lens element with refractive power, a second lens element with refractive power made of plastic material, a ring-shaped optical component made of a light absorbable material and disposed between the first lens element and the second lens element, and an optical refractive index matching layer disposed at one surface of the ring-shaped optical component; wherein the first lens element is disposed farther from the lens insertion opening than the second lens element; and wherein there is an air space between the first lens element and the second lens element on the lens barrel central axis.

Preferably, the optical lens assembly of the present invention comprises another optical refractive index matching layer disposed in a gap between the second lens element and the lens barrel and respectively connecting the second lens element and the lens barrel. A visible light absorption rate of the lens barrel is Ab which satisfies the following relation: Ab>90%.

In the optical lens assembly of the present invention, it is preferable that a visible light absorption rate of the ring-shaped optical component is As which satisfies the following relation: As>80%.

In the optical lens assembly of the present invention, it is preferable that the ring-shaped optical component is a light shielding element.

### BRIEF DESCRIPTION OF THE DRAWINGS

FIG. 1 is a partial view of a prior art optical lens assembly.

FIG. 2 is a partial view of an optical lens assembly having an optical refractive index matching layer in accordance with a first embodiment of the present invention.

FIG. 3 is a schematic view showing the calculation of a total reflection amount in accordance with the first embodiment of the present invention.

FIG. 4A is a partial view of an optical lens assembly having an optical refractive index matching layer in accordance with a second embodiment of the present invention, wherein the lenses are assembled through lap joint means.

FIG. 4B is a schematic view showing the detailed lap-joint structures of the first lens element and the second lens element in accordance with the second embodiment of the present invention.

FIG. 5 is a partial view of an optical lens assembly having an optical refractive index matching layer in accordance with a third embodiment of the present invention, wherein the lenses are assembled through lap joint means.

FIG. 6 is a partial view of an optical lens assembly having an optical refractive index matching layer in accordance with a fourth embodiment of the present invention, wherein the lenses are fixed through bonding means.

FIG. 7 is a partial view of an optical lens assembly having an optical refractive index matching layer in accordance with a fifth embodiment of the present invention, wherein the lenses are assembled through lap joint means.

FIG. 8 is a partial view of an optical lens assembly having an optical refractive index matching layer in accordance with a sixth embodiment of the present invention, wherein the lenses are assembled through lap joint means.

### DETAILED DESCRIPTION OF THE PREFERRED EMBODIMENTS

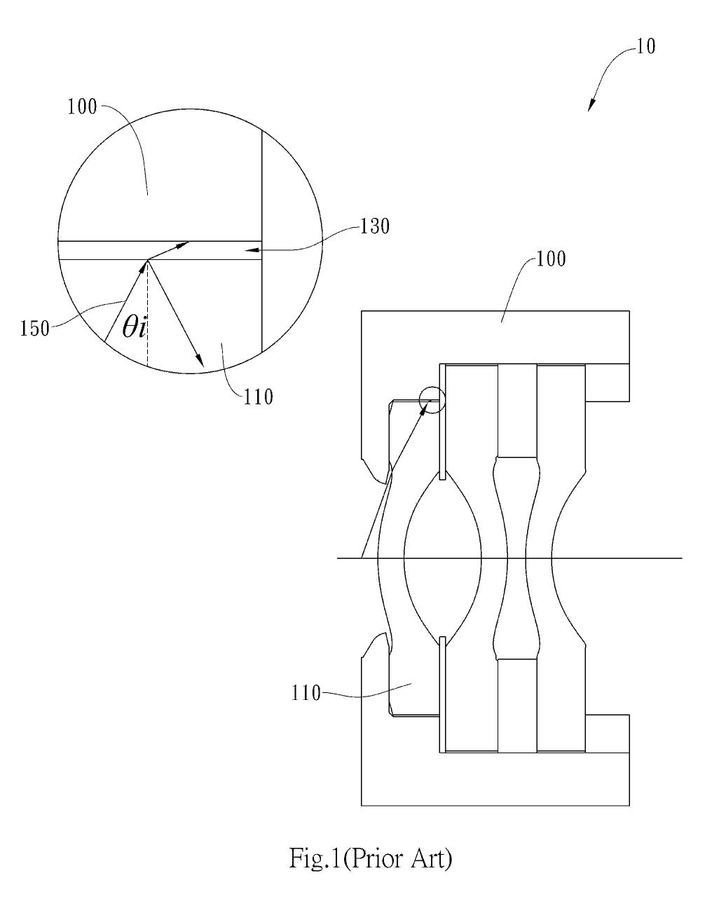

FIG. 1 is a partial view of a prior art optical lens assembly 10 having no optical refractive index matching layer. The optical lens assembly 10 comprises a lens barrel 100 and a lens 110. The optical lens assembly 10 may be a wide angle lens assembly or a telephoto lens assembly, and the angle of view thereof may be extremely large (over 90°) or extremely small (less than 10°) depending on its design. However, light, such as light 150 in FIG. 1, still enters the optical lens assembly 10 at a larger incident angle from the edge of the angle of view regardless of the size of the angle of view. The light 150 is incident to the upper edge of the lens 110 which is not closely engaged with the lens barrel 100 (the gap 130 in FIG. 1), thus the light 150 will be incident to an interface between the lens and air at an incident angle of θᵢ from the upper edge of the lens 110, and partial reflection and partial refraction will occur at the interface. The lens 110 may be made of glass, plastic material or other optical materials. Generally, the lens 110 has a refractive index of approximately 1.5 or higher regardless of the material. Take the commonly used optical glass BK7 as an example, its refractive index at the center of the visible light band is approximately 1.5168. Under the circumstance that the refractive index is approximately 1.5168, full reflection will occur on the interface between the upper edge of the lens 110 and air when 0, is slightly greater than 41°. Although a light shielding element can be disposed in the optical lens assembly of FIG. 1 to partially absorb the light reflected from the interface between the outer edge of the lens and air, the problem concerning the unexpected light is not completely solved because the total amount of reflected light is significant and a part of the light may once again be reflected into the lens assembly before reaching the light shielding element. Such problem that adversely affects image quality is closely related to the incident angle of the light and may become even more complicated with the occurrence of multiple reflections in the lens assembly, thus it is difficult to perform error detection. Therefore, it is more desirable to minimize the amount of reflection of the light incident to the edge of the lens 110 for the first time.

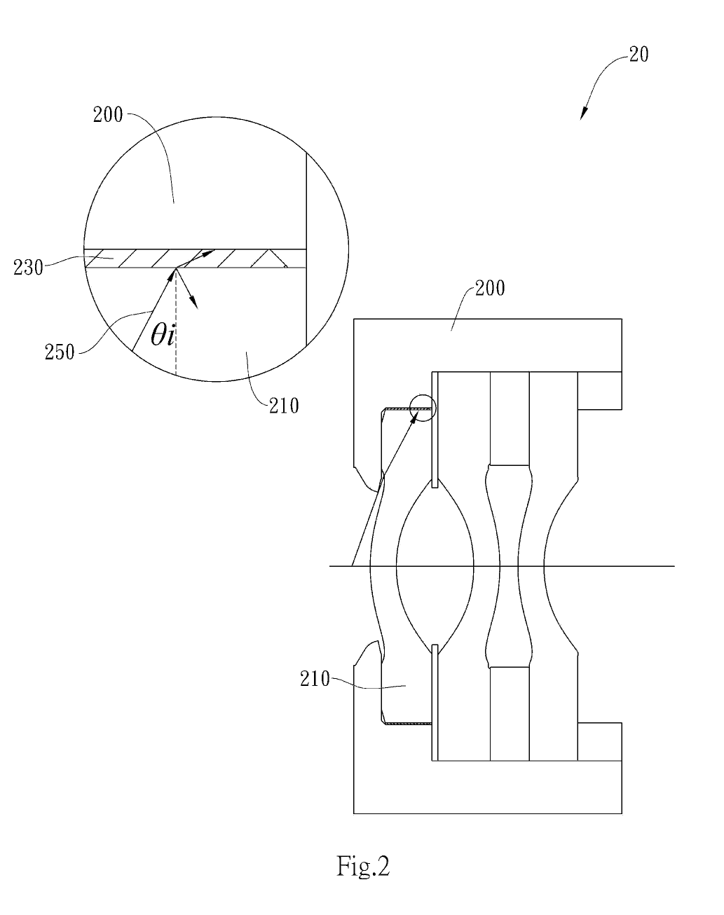

FIG. 2 is a partial view of an optical lens assembly 20 having an optical refractive index matching layer in accordance with a first embodiment of the present invention. The optical lens assembly 20 comprises a lens barrel 200, a lens 210, and an optical refractive index matching layer 230 made of an optically transmissive material and connecting the lens barrel 200 and an outer edge of the lens 210. The optical refractive index matching layer 230 respectively contacts the lens barrel 200 and the outer edge of the lens 210 to prevent the formation of an interface between the outer edge of the lens 210 and air, which would exhibit a high degree of refractive index variance, and thereby to reduce the reflection of light from the interface of the outer edge of the lens. When light, such as light 250 in FIG. 2, is incident to the optical lens assembly 20 at a larger angle from the edge of the field of view, the light is incident to an upper edge of the lens 210 and then partially refracted and reflected from an interface between the lens 210 and the optical refractive index matching layer 230. The majority of the light refracted to the optical refractive index matching layer 230 will be absorbed by the lens barrel 200 whose inner side is made of a dark-colored light absorbable material. To further reduce the reflection inside the lens barrel, the light extinction processing, such as anti-reflection coating or texturing processing, can be performed on the inner surface of the lens barrel. Generally, the inner side of the lens barrel has a light absorption rate of above 90%, and it is common that the inner side of the lens barrel has a light absorption rate of 95% or above. The arrangement of the optical refractive index matching layer 230 enables the probability of the occurrence of full reflection at the outer edge of the lens 210 to be significantly reduced or eliminated. The optical refractive index matching layer 230 is capable of reducing the reflection even under the circumstance that full reflection will not occur so that the majority of the light can be directed to the optical refractive index matching layer 230 and then absorbed by the lens barrel.

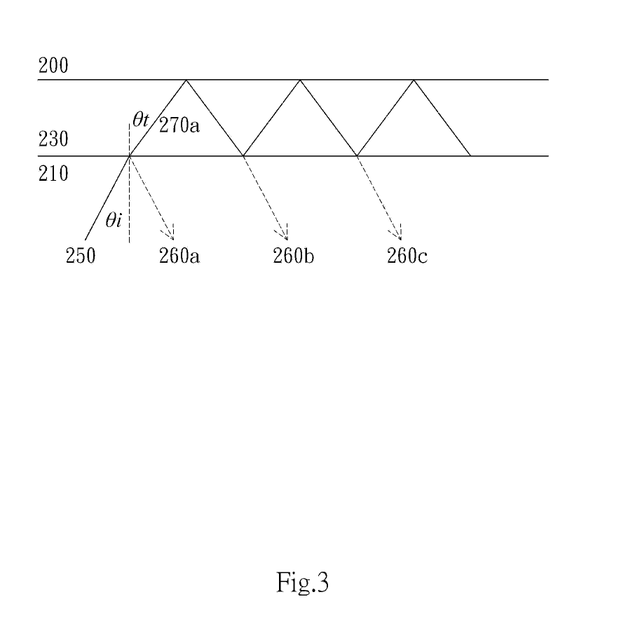

FIG. 3 is a detailed enlarged view of the lens 210, the optical refractive index matching layer 230 and the lens barrel 200. FIG. 3 shows how full reflection can be prevented and how the total amount of reflection can be reduced. Please note that the optical refractive index matching layer 230 can be a coating layer made of an optically transmissive material and having a thickness ranging from approximately 0.005 mm to 0.02 mm. If the optically transmissive material has a lower transmittance, the absorption of light will facilitate reducing overall reflection. However, the framework provided by the present invention enables an effective reduction in reflection even if the optical refractive index matching layer 230 has a transmittance of above 80%.

In FIG. 3, the light 250 is initially incident to the interface between the lens 210 and the optical refractive index matching layer 230 at an incident angle θᵢ from the edge of the lens 210. A portion 260a of the light 250 is reflected while another portion 270a of the light 250 is refracted to the optical refractive index matching layer 230 at a refractive angle of θₜ. If a refractive index of the lens 210 is n_{g}, and a refractive index of the optical refractive index matching layer 230 is n_{c}, the refraction satisfies Snell's Law:

n_{g} SIN θᵢ=n_{c} SIN θₜ

According to the above equation, n_{c} and n_{g} satisfy the following relation:

SIN θᵢ>/n_{g}

Regarding the occurrence of full reflection, as the refractive index n_{c} of the optical refractive index matching layer 230 is greater than the refractive index (approximately 1) of air, full reflection is less likely to occur with the arrangement of the optical refractive index matching layer 230 between the lens 210 and the lens barrel 200. Full reflection can be completely prevented even under the circumstance that n_{c} is greater than n_{g}.

The total amount of reflection of the light 250 incident to the interface between the lens 210 and the optical refractive index matching layer 230 will be estimated below. According to the polarization of the light 250, the reflection coefficients of the energy between the lens 210 and the optical refractive index matching layer 230 are Rₛ and Rₚ. Rₛ which respectively satisfy the following relations:

Rₛ=[(n_{g} COS θᵢ−n_{c} COS θₜ)/(n_{g} COS θᵢ+n_{c} COS θₜ)]²

Rₚ=[(n_{g} COS θₜ−n_{c} COS θᵢ)/(n_{g} COS θₜ+n_{c} COS θᵢ)]²

Under normal circumstances, the light 250 is not polarized and thus not characterized by polarization. Therefore, the ratio R of the energy of the reflected light 260a to the energy of the incident light 250 satisfies the following relation: R=(Rₛ+Rₚ)/2

The ratio T of the energy of the refracted light 270a to the energy of the incident light 250 satisfies the following relation:

T=1−R

Under the circumstance that the deduction is not affected, suppose the optical refractive index matching layer 230 does not absorb any light, the majority of the refracted light 270a will be absorbed by the lens barrel. As shown in FIG. 3, a small amount of light is still reflected by the lens barrel 200 and the interface between the optical refractive index matching layer 230 and the lens 210 for several times to generate the reflected lights 260b and 260c. Such multiple reflected lights will deteriorate rapidly when the number of reflection increases. The total energy of the reflected lights is the summation of the energy of the light 260a and the multiple reflected lights, such as the lights 260b and 260c. As described above, the ratio of the energy of the reflected light 260a to the energy of the incident light 250 is R (hereafter referred to as the first reflection coefficient), and the ratio of the energy of the multiple reflected lights to the energy of the incident light 250 is Rₘ (hereafter referred to as the multi-reflection coefficient), thus the ratio of the total reflection energy to the energy of the incident light 250 satisfies the relation of R_{T}=R±Rₘ(R_{T} is referred to as the total reflection coefficient).

In the first example of the embodiment, the incident angle θᵢ of the incident light 250 is 36°, the visible light absorption rate Ab of the lens barrel is 90%, and the refractive index of the lens 210 is 1.5168 (d-line). Table 1 below lists the first reflection coefficient R, the multi-reflection coefficient Rₘ, and the total reflection coefficient R_{T} of various optical refractive index matching layer materials (the refractive index ranges from 1 to 2.5) estimated according to the above method.

TABLE 1
θᵢ = 36° Ab = 90%

| N_{g} | N_{c} | R | Rₘ | R_{T} |
|---|---|---|---|---|
| 1.5168 | 1 | 0.109 | 0.080 | 0.190 |
| 1.5168 | 1.1 | 0.048 | 0.091 | 0.139 |
| 1.5168 | 1.2 | 0.022 | 0.096 | 0.118 |
| 1.5168 | 1.3 | 0.009 | 0.098 | 0.107 |
| 1.5168 | 1.4 | 0.002 | 0.10 | 0.102 |
| 1.5168 | 1.5 | 0.000 | 0.10 | 0.10 |
| 1.5168 | 1.6 | 0.001 | 0.10 | 0.101 |
| 1.5168 | 1.7 | 0.004 | 0.099 | 0.103 |
| 1.5168 | 1.8 | 0.009 | 0.098 | 0.107 |
| 1.5168 | 1.9 | 0.014 | 0.097 | 0.112 |
| 1.5168 | 2 | 0.021 | 0.096 | 0.117 |
| 1.5168 | 2.1 | 0.029 | 0.095 | 0.123 |
| 1.5168 | 2.2 | 0.037 | 0.093 | 0.130 |
| 1.5168 | 2.3 | 0.046 | 0.091 | 0.137 |
| 1.5168 | 2.4 | 0.055 | 0.090 | 0.145 |
| 1.5168 | 2.5 | 0.064 | 0.088 | 0.152 |

Referring to data in Table 1, the circumstance that the refractive index of the material is 1 can be regarded as the circumstance that no optical refractive index matching layer is added (air has a refractive index of approximately 1) and is compared with the data of other optical coating materials listed in Table 1. As can be seen from the data in Table 1, the total reflection is mainly contributed from the accumulated multiple reflections portion when the incident angle θᵢ is 36°, with the exception of N_{c}=1 (no optical refractive index matching layer is provided). In this example, if the lens barrel has a higher visible light absorption rate, the multi-reflection coefficient Rₘ will decrease. The multi-reflection coefficient Rₘ is more related to the visible light absorption rate of the lens barrel than the optical refractive index matching layer. On the other hand, the closer the refractive index of the optical refractive index matching layer is to the refractive index of the lens, the lower the first reflection coefficient R is, and the total reflection coefficient R_{T} also decreases correspondingly. In this example, the total reflection amount is not large, but the arrangement of the optical refractive index matching layer still reduces the total reflection amount. While the lens barrel in each example of the embodiment has a visible light absorption rate Ab of 90%, Ab can be above 95% in real practice. If a lens barrel has a visible light absorption rate of approximately 10%, multiple reflections will not occur; meanwhile, the total reflection amount can be reduced to below 1% if the optical refractive index matching layer and the refractive index of the lens match well, thereby completely controlling the internal reflection.

In the second example of the embodiment, the incident angle θᵢ of the incident light 250 is 38°, the visible light absorption rate Ab of the lens barrel is 90%, and the refractive index of the lens 210 is 1.5168 (d-line). Table 2 below lists the first reflection coefficient R, the multi-reflection coefficient Rₘ, and the total reflection coefficient R_{T} of various optical refractive index matching layer materials (the refractive index ranges from 1 to 2.5) estimated according to the above method.

TABLE 2
θᵢ = 38° Ab = 90%

| N_{g} | N_{c} | R | Rₘ | R_{T} |
|---|---|---|---|---|
| 1.5168 | 1 | 0.162 | 0.071 | 0.234 |
| 1.5168 | 1.1 | 0.060 | 0.089 | 0.149 |
| 1.5168 | 1.2 | 0.026 | 0.095 | 0.121 |
| 1.5168 | 1.3 | 0.010 | 0.098 | 0.108 |
| 1.5168 | 1.4 | 0.002 | 0.10 | 0.102 |
| 1.5168 | 1.5 | 0.000 | 0.10 | 0.10 |
| 1.5168 | 1.6 | 0.001 | 0.10 | 0.101 |
| 1.5168 | 1.7 | 0.004 | 0.099 | 0.103 |
| 1.5168 | 1.8 | 0.009 | 0.098 | 0.107 |
| 1.5168 | 1.9 | 0.015 | 0.097 | 0.112 |
| 1.5168 | 2 | 0.022 | 0.096 | 0.118 |
| 1.5168 | 2.1 | 0.030 | 0.094 | 0.124 |
| 1.5168 | 2.2 | 0.038 | 0.093 | 0.131 |
| 1.5168 | 2.3 | 0.047 | 0.091 | 0.138 |
| 1.5168 | 2.4 | 0.056 | 0.090 | 0.145 |
| 1.5168 | 2.5 | 0.065 | 0.088 | 0.153 |

According to the data in Table 2, the first reflection coefficient R and the total reflection coefficient R_{T} both increase with the increasing incident angle but the result is similar to that of the first example. The total reflection is mainly contributed from the accumulated multiple reflections portion, with the exception of N_{c}=1 (no optical refractive index matching layer is provided). The closer the refractive index of the optical refractive index matching layer is to the refractive index of the lens, the lower the total reflection coefficient R_{T} is because of the decrease of the first reflection coefficient R.

In the third example of the embodiment, the incident angle θᵢ of the incident light 250 is 40°, the visible light absorption rate Ab of the lens barrel is 90%, and the refractive index of the lens 210 is 1.5168 (d-line). Table 3 below lists the first reflection coefficient R, the multi-reflection coefficient Rₘ, and the total reflection coefficient R_{T} of various optical refractive index matching layer materials (the refractive index ranges from 1 to 2.5) estimated according to the above method.

TABLE 3
θᵢ = 40° Ab = 90%

| N_{g} | N_{c} | R | Rₘ | R_{T} |
|---|---|---|---|---|
| 1.5168 | 1 | 0.305 | 0.050 | 0.355 |
| 1.5168 | 1.1 | 0.080 | 0.085 | 0.166 |
| 1.5168 | 1.2 | 0.031 | 0.094 | 0.125 |
| 1.5168 | 1.3 | 0.011 | 0.098 | 0.109 |
| 1.5168 | 1.4 | 0.003 | 0.099 | 0.102 |
| 1.5168 | 1.5 | 0.000 | 0.10 | 0.10 |
| 1.5168 | 1.6 | 0.001 | 0.10 | 0.101 |
| 1.5168 | 1.7 | 0.004 | 0.099 | 0.104 |
| 1.5168 | 1.8 | 0.009 | 0.098 | 0.108 |
| 1.5168 | 1.9 | 0.016 | 0.097 | 0.113 |
| 1.5168 | 2 | 0.023 | 0.096 | 0.119 |
| 1.5168 | 2.1 | 0.031 | 0.094 | 0.125 |
| 1.5168 | 2.2 | 0.039 | 0.093 | 0.132 |
| 1.5168 | 2.3 | 0.048 | 0.091 | 0.139 |
| 1.5168 | 2.4 | 0.057 | 0.089 | 0.146 |
| 1.5168 | 2.5 | 0.066 | 0.088 | 0.154 |

In the third example of the embodiment, the incident angle θᵢ is 40°, which is only 2° greater than the incident angle of the previous example. However, the first reflection coefficient R has increased significantly under the circumstance that no optical refractive index matching layer is disposed, and this is a typical phenomenon that normally occurs when the incident angle is close to the total reflection critical angle (in this embodiment, the critical angle is slightly greater than 41°). This is when the optical refractive index matching layer has a great effect. Although the closer the refractive index of the optical refractive index matching layer is to the refractive index of the lens, the lower the total reflection coefficient R_{T} is, it can be seen from the data in Table 3 that even if the optical refractive index matching layer is significantly different in refractive index from the lens (for example, N_{c}=1.1 or N_{c}=2.5), the first reflection coefficient R and the total reflection coefficient R_{T} still decrease significantly compared with the circumstance that no optical refractive index matching layer is disposed. Therefore, there is a great deal of flexibility in the selection of material for the coating.

In the fourth example of the embodiment, the incident angle θᵢ of the incident light 250 is 42°, the visible light absorption rate Ab of the lens barrel is 90%, and the refractive index of the lens 210 is 1.5168 (d-line). Table 4 below lists the first reflection coefficient R, the multi-reflection coefficient Rₘ, and the total reflection coefficient R_{T} of various optical refractive index matching layer materials (the refractive index ranges from 1 to 2.5) estimated according to the above method.

TABLE 4
θᵢ = 42° Ab = 90%

| N_{g} | N_{c} | R | Rₘ | R_{T} |
|---|---|---|---|---|
| 1.5168 | 1 | 1.000 | 0 | 1.000 |
| 1.5168 | 1.1 | 0.116 | 0.079 | 0.195 |
| 1.5168 | 1.2 | 0.039 | 0.093 | 0.132 |
| 1.5168 | 1.3 | 0.013 | 0.098 | 0.111 |
| 1.5168 | 1.4 | 0.003 | 0.099 | 0.102 |
| 1.5168 | 1.5 | 0.000 | 0.10 | 0.10 |
| 1.5168 | 1.6 | 0.001 | 0.10 | 0.101 |
| 1.5168 | 1.7 | 0.005 | 0.099 | 0.104 |
| 1.5168 | 1.8 | 0.010 | 0.098 | 0.108 |
| 1.5168 | 1.9 | 0.017 | 0.097 | 0.113 |
| 1.5168 | 2 | 0.024 | 0.096 | 0.119 |
| 1.5168 | 2.1 | 0.032 | 0.094 | 0.126 |
| 1.5168 | 2.2 | 0.041 | 0.092 | 0.133 |
| 1.5168 | 2.3 | 0.050 | 0.091 | 0.140 |
| 1.5168 | 2.4 | 0.059 | 0.089 | 0.148 |
| 1.5168 | 2.5 | 0.068 | 0.087 | 0.156 |

As described above, in this example, the incident angle exceeds the critical angle, full reflection occurs, and the total reflection coefficient R_{T} is 1 without the optical refractive index matching layer. This is when the optical refractive index matching layer has a great effect. Even if the refractive index of the optical refractive index matching layer is as low as 1.2 or as high as 2.4, the total reflection coefficient R_{T} is controlled within 15%. Generally speaking, the optical refractive index matching layers have great effects as long as the relation of 0.75<n_{c}/n_{g}<1.50 is satisfied. To further control the total reflection coefficient R_{T} within 11%, it merely requires the satisfaction of the relation of 0.85<n_{c}/n_{g}<1.25. Regarding the elimination of reflection, it is close to the optimal effect under the framework of the present invention. According to the data in Table 4, the total reflection coefficient R_{T} remains to be approximately 10% even if the refractive index of the optical refractive index matching layer is extremely close to the refractive index of the lens.

The above deduction shows that the relation between the refractive index of the lens and the refractive index of the optical refractive index matching layer does not limit the type of material used to make the lens. Therefore, the lens can be made of glass, plastic material or any other material that satisfies optical requirements under the framework of the present invention. Regarding various materials, selection of material for the optical refractive index matching layer can be made according to the limitation on the refractive index of the optical refractive index matching layer as described above. As the range of the refractive index of the optical refractive index matching layer is wide, selection of material can be made to meet other requirements in system design. For example, the optical refractive index matching layer is viscous and is advantageous in fixing the lens to reinforce the rigidity of the lens assembly. Specifically, the optical refractive index matching layer can be UV glue having the aforementioned features. Moreover, the refractive indexes of UV glues available on the market generally range from 1.47 to 1.54 that match well with the refractive indexes of materials commonly used to make lenses.

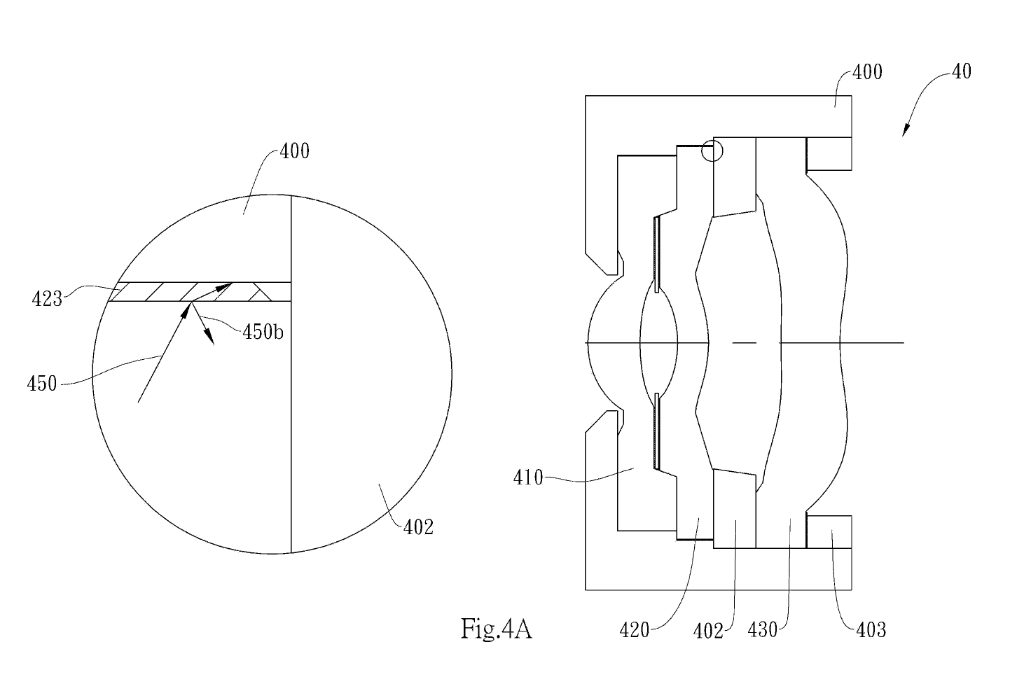

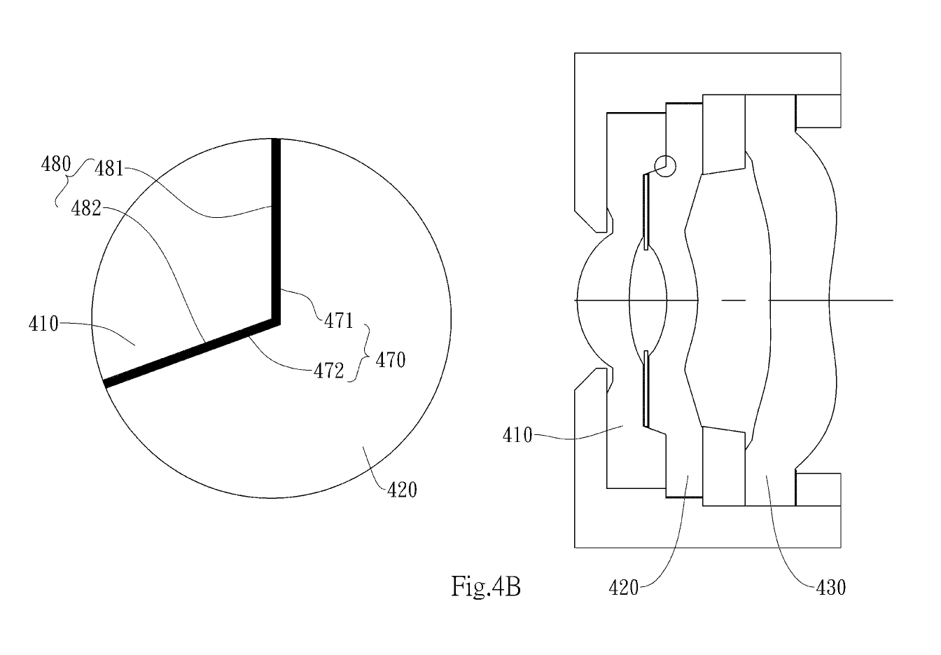

The optical refractive index matching layer described in the first embodiment of the present invention is applicable to the interface between any lens and the lens barrel in the optical lens assembly. FIG. 4A is a partial view of a second embodiment of the present invention. In the second embodiment of the present invention, there is provided an optical lens assembly 40 comprising: a lens barrel 400; a first lens element 410; a second lens element 420; a third lens element 430; an optical refractive index matching layer 423 connecting the lens barrel 400 and an outer edge of the second lens element 420 to reduce the reflection of light from the interface at the outer edge of the second lens element 420; a spacer ring 402; and a ring-shaped fixation member 403 configured to seal lenses inside the lens barrel; wherein the lens barrel 400 has a lens insertion opening through which the first lens element 410, the second lens element 420 and the third lens element 430 are inserted into the lens barrel 400; wherein the first lens element 410 and the second lens element 420 are joined through lap joint means and the centers thereof are aligned with the lens barrel central axis; wherein the first lens element 410 is disposed farther from the lens insertion opening than the second lens element 420, and the second lens element 420 is disposed farther from the lens insertion opening than the third lens element 430; and wherein there is an air space between the first lens element 410 and the second lens element 420 on the lens barrel central axis, and there is another air space between the second lens element 420 and the third lens element 430 on the lens barrel central axis.

In this embodiment, the first lens element 410 has a bulging first lens element fitting surface 480 (which consists of a first abutment section 481 and a second abutment section 482 of the first lens element 410, as shown in FIG. 4B) lap joining a second lens element fitting surface 470 (which consists of a first abutment section 471 and a second abutment section 472 of the second lens element 420, as shown in FIG. 4B) of the second lens element 420 (the first abutment section 481 of the first lens element 410 abuts against the first abutment section 471 of the second lens element 420, and the second abutment section 482 of the first lens element 410 abuts against the second abutment section 472 of the second lens element 420). In this lap-joint structure, the first lens element 410 is in direct contact with the second lens element 420, thus the light (for example, light 450 in FIG. 4A) incident to the first lens element 410 at a larger angle will pass the interface via which the two lenses are lap joined and be incident to an upper edge of the second lens element 420, and this may form unexpected light in the optical lens assembly 40. Therefore, the optical refractive index matching layer 423 is disposed between the second lens element 420 and the lens barrel 400 in the second embodiment of the present invention.

As described above, the arrangement of the optical refractive index matching layer will not pose any limitation on the materials used to make lenses of the optical lens assembly. Therefore, in this embodiment, the first lens element 410 and the second lens element 420 can be made of glass or plastic material. Most plastic lenses are fabricated by molding, thus aspheric surfaces can be made easily. Furthermore, the size of the optical lens assembly can be reduced or the optical quality can be increased. Most of the lenses in the optical lens assembly are provided with coating layers on the surfaces thereof to reduce the reflection between. The arrangement of the coating layer will not affect the arrangement of the optical refractive index matching layer in the present invention.

As demonstrated by various examples of the first embodiment, even if the refractive index of the optical refractive index matching layer matches well with the refractive index of the lens, a portion of the reflected light will still be reflected back to the interior of the lens assembly from the outer edge of the lens due to the limitation of the absorption rate of the lens barrel. Therefore, when the visible light absorption rate Ab of the lens barrel cannot be increased under certain circumstance (for example, the manufacturing cost is taken into consideration), additional means is required to deal with the residual reflected light generated thereby. In the second embodiment of the present invention shown in FIG. 4A, although the optical refractive index matching layer 423 is disposed between the lens barrel 400 and the second lens element 420, it is possible that a portion 450b of the incident light 450 will be reflected. In this embodiment, the residual reflected light can be absorbed by the spacer ring 402. To reduce the reflection from the interface, an optical refractive index matching layer can be disposed between the second lens element and the spacer ring, as shown in the third embodiment of the present invention.

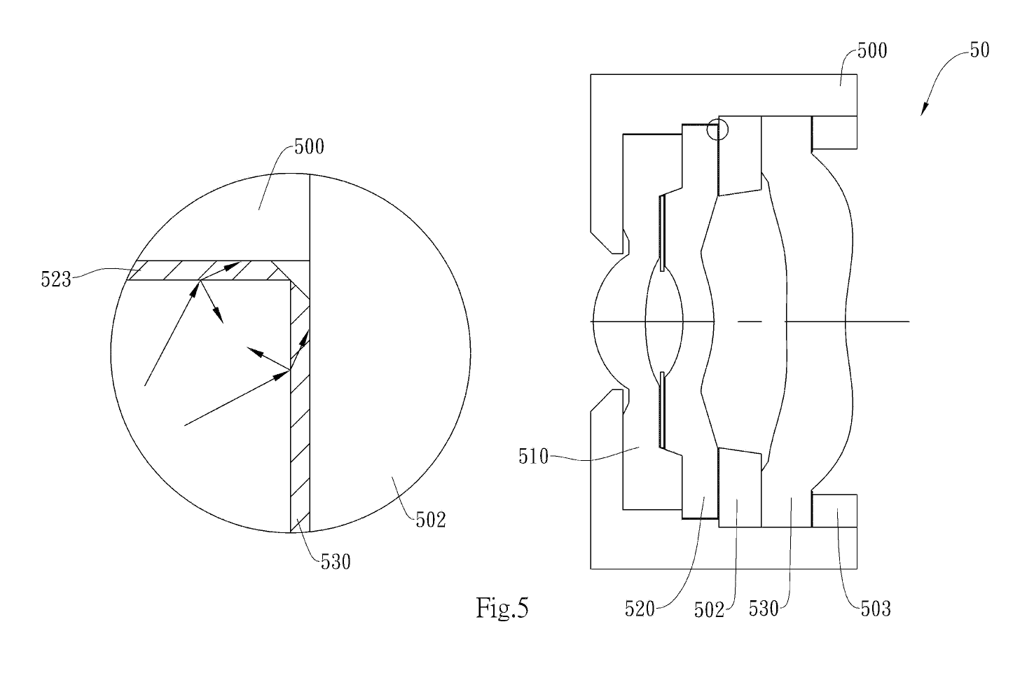

FIG. 5 is a partial view of a third embodiment of the present invention. In the third embodiment of the present invention, there is provided an optical lens assembly 50 comprising: a lens barrel 500; a first lens element 510; a second lens element 520; a third lens element 530; an optical refractive index matching layer 523; a spacer ring 502; and a ring-shaped fixation member 503. The arrangement of various elements in the optical lens assembly 50 is similar to that of the second embodiment of the present invention. The third embodiment is different from the second embodiment in that the optical refractive index matching layer 523 is disposed not only between the second lens element 520 and the lens barrel 500 but also between the second lens element 520 and the spacer ring 502.

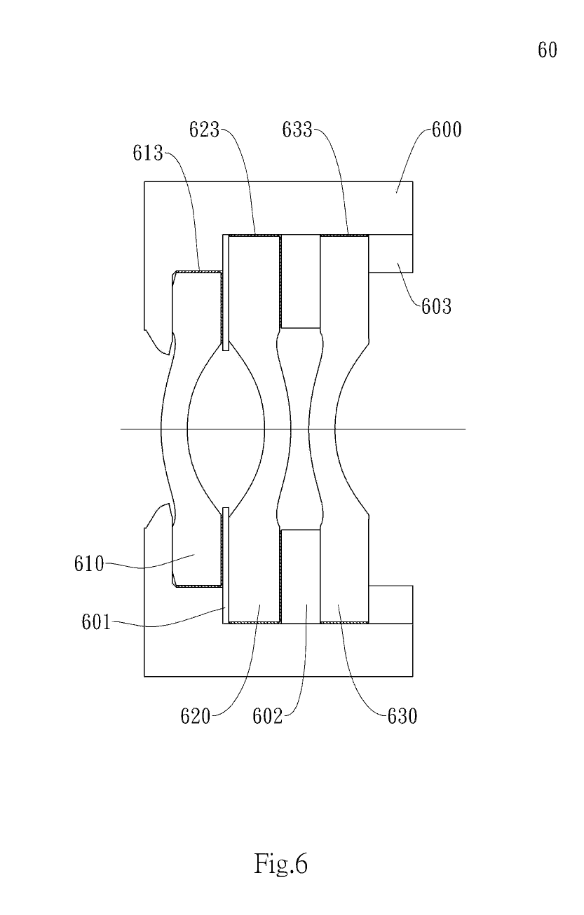

FIG. 6 is a partial view of a fourth embodiment of the present invention. In fourth embodiment of the present invention, there is provided an optical lens assembly 60 comprising: a lens barrel 600; a first lens element 610; a second lens element 620; a third lens element 630; a light shielding element 601; a spacer ring 602; an optical refractive index matching layer 613; an optical refractive index matching layer 623; an optical refractive index matching layer 633; and a ring-shaped fixation member 603. In this embodiment, the lenses are fixed inside the lens barrel 600 by bonding. The light shielding element 601 can serve multiple functions. The light shielding element 601 can serve as a stop for the system or block the light irrelevant to the image formation, such as the light incident to the area outside the image circle or the light reflected from the outer edge of the first lens element 610. The spacer ring 602 not only separates the second lens element 620 and the third lens element 630 but also partially blocks the unexpected light. Therefore, in this embodiment, the optical refractive index matching layer 613 is located at a gap between the first lens element 610 and the lens barrel 600 and at a gap between the first lens element 610 and the light shielding element 601, and contacts respectively with the first lens element, the lens barrel and the light shielding element; the optical refractive index matching layer 623 is located at a gap between the second lens element 620 and the lens barrel 600 and at a gap between the second lens element 620 and the spacer ring 602, and contacts respectively with the second lens element, the lens barrel and the spacer ring; the optical refractive index matching layer 633 is only disposed in a gap between the third lens element 630 and the lens barrel 600.

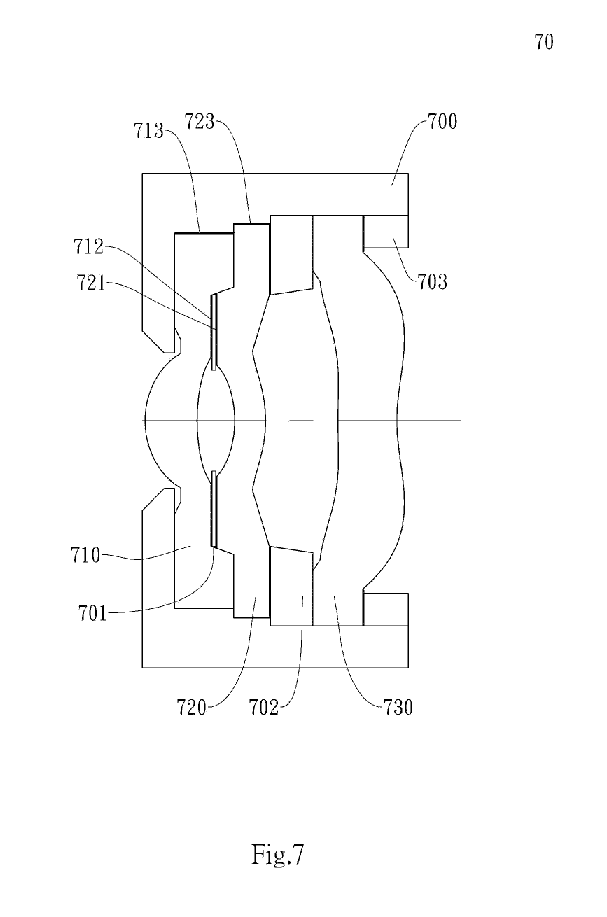

FIG. 7 is a partial view of a fifth embodiment of the present invention. In the fifth embodiment of the present invention, there is provided an optical lens assembly 70 comprising: a lens barrel 700; a first lens element 710; a second lens element 720; a third lens element 730; a light shielding element 701; a spacer ring 702; an optical refractive index matching layer 712; an optical refractive index matching layer 721; an optical refractive index matching layer 713; an optical refractive index matching layer 723; and a ring-shaped fixation member 703. In this embodiment, the first lens element 710 and the second lens element 720 are lap joined; the optical refractive index matching layer 713 is disposed in a gap between the first lens element 710 and the lens barrel 700, and contacts respectively with the first lens element and the lens barrel; the optical refractive index matching layer 723 is disposed in a gap between the second lens element 720 and the lens barrel 700 and a gap between the second lens element 720 and the spacer ring 702, and contacts respectively with the second lens element, the lens barrel and the spacer ring. The light shielding element 701 may serve as a stop for the system and may be configured to block the light irrelevant to the image formation. The optical refractive index matching layer 712 is disposed in a gap between the light shielding element 701 and the first lens element 710, and contacts respectively with the first lens element and the light shielding element. The optical refractive index matching layer 721 is disposed in a gap between the light shielding element 701 and the second lens element 720, and contacts respectively with the second lens element and the light shielding element.

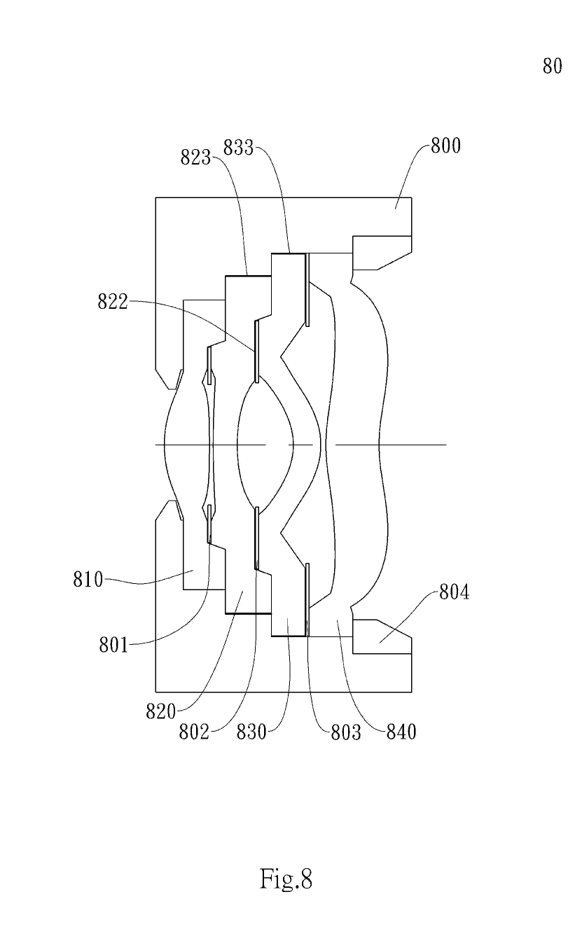

FIG. 8 is a partial view of a sixth embodiment of the present invention. In the sixth embodiment of the present invention, there is provided an optical lens assembly 80 comprising: a lens barrel 800; a first lens element 810; a second lens element 820; a third lens element 830; a fourth lens 840; a light shielding element 801; a light shielding element 802; a light shielding element 803; an optical refractive index matching layer 823; an optical refractive index matching layer 822; an optical refractive index matching layer 833; and a ring-shaped fixation member 804. In this embodiment, the first lens element 810, the second lens element 820 and the third lens element 830 are lap joined; the second lens element 820 has two fitting surfaces; the optical refractive index matching layer 823 is disposed in a gap between the second lens element 820 and the lens barrel 800, and contacts respectively with the second lens element and the lens barrel; the optical refractive index matching layer 833 is disposed in a gap between the third lens element 830 and the lens barrel 800 and a gap between the third lens element 830 and the light shielding element 803, and contacts respectively with the third lens element, the lens barrel and the light shielding element; the optical refractive index matching layer 822 is disposed in a gap between the second lens element 820 and the light shielding element 802, and contacts respectively with the second lens element and the light shielding element.

Different data of the different embodiments are used to explain the implementation methods and to prove the effect of the present invention. Therefore, any optical lens assembly of the same structure is considered to be within the scope of the present invention even if it uses different data. The embodiments depicted above and the appended drawings are exemplary and are not intended to limit the scope of the present invention.

What is claimed is:

1. An optical lens assembly, comprising:
a lens barrel made of plastic material and having a lens insertion opening and a lens barrel central axis, the lens barrel accommodating:
a first lens element with refractive power;
a second lens element with refractive power made of plastic material;
a third lens element with refractive power; and
an optical refractive index matching layer disposed between the lens barrel and the second lens element while connecting respectively with the lens barrel and the second lens element; wherein the first lens element is disposed farther from the lens insertion opening than the second lens element, and the second lens element is disposed farther from the lens insertion opening than the third lens element; and wherein there is an air space between any two adjacent lens elements on the lens barrel central axis.

2. The optical lens assembly according to claim 1, wherein the second lens element comprises a second lens element fitting surface abutting against an adjacent lens element, and the second lens element fitting surface and the lens barrel central axis form an angle A that satisfies the following relation: |A|<45 degrees.

3. The optical lens assembly according to claim 2, wherein the second lens element fitting surface is arranged at one side of the second lens element away from the lens insertion opening.

4. The optical lens assembly according to claim 3, wherein the first lens element has a first lens element fitting surface joining the second lens element fitting surface, and the first lens element fitting surface is disposed farther away from the lens barrel central axis than the second lens element fitting surface.

5. The optical lens assembly according to claim 2, wherein the second lens element comprises a front surface facing away from the lens insertion opening and a back surface facing the lens insertion opening; and wherein each of the front surface and the back surface comprises a second lens element fitting surface.

6. The optical lens assembly according to claim 2, wherein at least one of the first lens element and the second lens element has at least one aspheric surface.

7. The optical lens assembly according to claim 2, wherein a visible light absorption rate of the lens barrel is Ab which satisfies the following relation:
Ab>80%.

8. The optical lens assembly according to claim 2 further comprising a ring-shaped optical component at one side of the second lens element.

9. The optical lens assembly according to claim 8, wherein the ring-shaped optical component has an outer diameter Ds, the second lens element has an outer diameter D2, and they satisfy the following relation: Ds/D2<1.

10. The optical lens assembly according to claim 8, wherein a refractive index of the optical refractive index matching layer is n_{c}, a refractive index of the second lens element is n₂, and they satisfy the following relation:
0.75<n_{c}/n₂<1.50.

11. The optical lens assembly according to claim 10, wherein the refractive index of the optical refractive index matching layer is n_{c}, the refractive index of the second lens element is n₂, and they satisfy the following relation:
0.8<n_{c}/n₂<1.2.

12. The optical lens assembly according to claim 1, wherein the optical refractive index matching layer is made of a polymer material.

13. The optical lens assembly according to claim 1, wherein a visible light transmittance of the optical refractive index matching layer is Tc which satisfies the following relation: Tc>80%.

14. An optical lens assembly, comprising:
a lens barrel made of plastic material and having a lens insertion opening and a lens barrel central axis, the lens barrel accommodating:
a first lens element with refractive power;
a second lens element with refractive power made of plastic material;
a ring-shaped optical component made of a light absorbable material and disposed between the first lens element and the second lens element; and
an optical refractive index matching layer disposed at one surface of the ring-shaped optical component; wherein the first lens element is disposed farther from the lens insertion opening than the second lens element; and wherein there is an air space between the first lens element and the second lens element on the lens barrel central axis.

15. The optical lens assembly according to claim 14, wherein the second lens element comprises a second lens element fitting surface abutting against an adjacent lens element; the second lens element fitting surface and the lens barrel central axis form an angle A that satisfies the following relation:

|A|<45 degrees.

16. The optical lens assembly according to claim 15, wherein the optical refractive index matching layer is disposed between the first lens element and the ring-shaped optical component and respectively connects the first lens element and the ring-shaped optical component; and wherein a refractive index of the optical refractive index matching layer is n_{c}, a refractive index of the first lens element is n₁, and they satisfy the following relation:
0.8<n_{c}/n₁<1.2.

17. The optical lens assembly according to claim 15 further comprising another optical refractive index matching layer disposed between the second lens element and the lens barrel and respectively connecting the second lens element and the lens barrel, wherein a visible light absorption rate of the lens barrel is Ab which satisfies the following relation:
Ab>90%.

18. The optical lens assembly according to claim 15, wherein the second lens element fitting surface is arranged at one side of the second lens element away from the lens insertion opening.

19. The optical lens assembly according to claim 18, wherein the first lens element has a first lens element fitting surface joining the second lens element fitting surface, and the first lens element fitting surface is disposed farther away from the lens barrel central axis than the second lens element fitting surface.

20. The optical lens assembly according to claim 15, wherein the second lens element comprises a front surface facing away from the lens insertion opening and a back surface facing the lens insertion opening; and wherein each of the front surface and the back surface comprises a second lens element fitting surface.

21. The optical lens assembly according to claim 14, wherein at least one of the first lens element and the second lens element has at least one aspheric surface.

22. The optical lens assembly according to claim 14, wherein a visible light absorption rate of the ring-shaped optical component is As which satisfies the following relation:
As>80%.

23. The optical lens assembly according to claim 14, wherein the ring-shaped optical component has an outer diameter Ds, the second lens element has an outer diameter D2, and they satisfy the following relation:
Ds/D2<1.

24. The optical lens assembly according to claim 14, wherein the ring-shaped optical component is a light shielding element.

25. The optical lens assembly according to claim 14, wherein the optical refractive index matching layer is made of a polymer material.

26. The optical lens assembly according to claim 14, wherein a visible light transmittance of the optical refractive index matching layer is Tc which satisfies the following relation:
Tc>80%.
